(19) United States
(12) Patent Application Publication
(10) Pub. No.: US 2017/0266744 A1
(43) Pub. Date: Sep. 21, 2017

(54) WIRE ELECTRIC DISCHARGE MACHINE, CONTROL METHOD OF CONTROL DEVICE OF WIRE ELECTRIC DISCHARGE MACHINE, AND POSITIONING METHOD

(71) Applicant: Mitsubishi Electric Corporation, Tokyo (JP)

(72) Inventors: Daisuke SEKIMOTO, Tokyo (JP); Takayuki NAKAGAWA, Tokyo (JP); Tomoaki TAKADA, Tokyo (JP)

(73) Assignee: Mitsubishi Electric Corporation, Tokyo (JP)

(21) Appl. No.: 15/300,920

(22) PCT Filed: Oct. 30, 2015
(86) PCT No.: PCT/JP2015/080852

§ 371 Date: Sep. 30, 2016

(51) Int. Cl. B23H 7/32; B23H 7/26; G01D 5/241; B23H 7/10

(52) U.S. Cl. CPC B23H 7/32; B23H 7/10; B23H 7/26; G01D 5/2417

(57) ABSTRACT

An object of the present invention is to accurately position a wire electrode and a work. A control device included in a wire electric discharge machine of the present invention causes, in a state in which movement of the wire electrode in a longitudinal direction is stopped, a capacitance measuring section to measure capacitance while causing a driving section to relatively move a wire electrode and a work, thereafter causes, in a state in which the control device causes a wire moving section to move the wire electrode in the longitudinal direction, the capacitance measuring section to measure the capacitance, and causes the driving section to adjust relative positions of the wire electrode and the work.

### FIELD

The present invention relates to a wire electric discharge machine that applies a machining voltage between a wire electrode and a work and applies electric discharge machining to the work, a control method of a control device of the wire electric discharge machine, and a positioning method.

### BACKGROUND

In wire electric discharge machining, it is necessary to accurately grasp a positional relation between electrodes, that is, between a wire electrode and a work prior to machining and execute positioning between electrodes. A conventional positioning method between electrodes in the wire electric discharge machining is generally a method of detecting electric contact between a wire electrode and a work as described in Patent Literature 1 and Patent Literature 2.

### CITATION LIST

### Patent Literature

Patent Literature 1: Japanese Patent Application Laid-Open No. H4-171120

Patent Literature 2: Japanese Patent Application Laid-Open No. S60-135127

### SUMMARY

### Technical Problem

In the positioning method described in Patent Literature 1 and Patent Literature 2, the wire electrode vibrates during movement of the wire electrode. Therefore, electric contact is detected when the work approaches a range of the vibration of the wire electrode. At this point, the amplitude and the frequency of the vibration of the wire electrode are not fixed because of differences in the strength and the direction of tension applied to wire electrodes between wire electric discharge machines. Therefore, in the positioning method described in Patent Literature 1 and Patent Literature 2, it is difficult to accurately detect a positional relation between electrodes on the basis of only the detection of the electric contact. Therefore, in the positioning method described in Patent Literature 1 and Patent Literature 2, even when positioning of the wire electrode is performed on the same work, the position between electrodes fluctuates by a vibration width of the wire electrode.

When the movement of the wire electrode is stopped and the positioning is performed, fluctuation in the position of the wire electrode occurs in a range of a clearance, which is a gap of a wire piercing-through portion in a die that holds the wire electrode. Therefore, it is difficult to accurately grasp the positional relation between electrodes.

In the positioning method described in Patent Literature 1 and Patent Literature 2, when a wire electrode, which is an extra fine wire having an outer diameter of 70 micrometers or less, is positioned, electric resistance between the wire electrode and a work increases because the wire electrode is thin. It is sometimes difficult to accurately detect a position where the wire electrode and the work are in contact. In this way, in the positioning method described in Patent Literature 1 and Patent Literature 2, it is sometimes difficult to accurately position the wire electrode and the work.

The present invention has been devised in view of the above and an object of the present invention is to obtain a wire electric discharge machine capable of accurately positioning a wire electrode and a work.

### Solution to Problem

To solve the problems and achieve the object, the present invention includes: a wire electrode that is applied with a machining voltage and causes electric discharge between the wire electrode and a work; a driving section that relatively moves the wire electrode and the work in a direction crossing a longitudinal direction of the wire electrode; a wire moving section that moves the wire electrode in the longitudinal direction; and a capacitance measuring section that measures capacitance between the wire electrode and the work. The present invention includes a control device that causes, in a state in which the movement of the wire electrode in the longitudinal direction is stopped, the capacitance measuring section to measure the capacitance while causing the driving section to relatively move the wire electrode and the work, thereafter, causes, in a state in which the control device causes the wire moving section to move the wire electrode in the longitudinal direction, the capacitance measuring section to measure the capacitance, and causes the driving section to adjust relative positions of the wire electrode and the work on the basis of a measurement result of the capacitance measuring section.

### Advantageous Effects of Invention

The wire electric discharge machine according to the present invention has an effect that it is possible to accurately position the wire electrode and the work.

### BRIEF DESCRIPTION OF DRAWINGS

FIG. 1 is a diagram showing the configuration of a wire electric discharge machine according to a first embodiment of the present invention.

FIG. 2 is a diagram showing an example of the configuration of a capacitance measuring section of the wire electric discharge machine according to the first embodiment of the present invention.

FIG. 3 is a diagram showing an example of the configuration of a control device of the wire electric discharge machine according to the first embodiment of the present invention.

FIG. 4 is a flowchart showing an example of a machining operation of the wire electric discharge machine according to the first embodiment of the present invention.

FIG. 5 is a diagram showing an example of a measurement result acquired at step ST5 in FIG. 4.

FIG. 6 is a diagram showing an example of calibration data acquired from the measurement result shown in FIG. 5.

FIG. 7 is a diagram showing an example of capacitance corresponding to an inter-electrode distance between a wire electrode and a work calculated at step ST9 in FIG. 4.

FIG. 8 is a diagram showing a state in which the wire electrode of the wire electric discharge machine according to the first embodiment of the present invention is stopped.

FIG. 9 is a diagram showing a state in which the wire electrode shown in FIG. 8 is moved.

FIG. 10 is a diagram showing a state in which a wire electrode is brought close to a work in a comparative example of the wire electric discharge machine according to the first embodiment of the present invention.

FIG. 11 is a diagram showing a state in which the wire electrode is set in contact with the work in the comparative example shown in FIG. 10.

FIG. 12 is a diagram showing a state in which it is possible to detect that the work is in contact with the wire electrode, which is an extra fine wire, in the comparative example shown in FIG. 10.

FIG. 13 is a perspective view showing a wire electrode a work before first cut of a wire electric discharge machine according to a second embodiment of the present invention.

FIG. 14 is a perspective view showing the wire electrode and the work before second cut of the wire electric discharge machine according to the second embodiment of the present invention.

FIG. 15 is a flowchart showing an example of a machining operation of a wire electric discharge machine according to a third embodiment of the present invention.

FIG. 16 is a diagram showing an example of an inter-electrode distance between a wire electrode and a work calculated by a control device of a wire electric discharge machine according to a fourth embodiment of the present invention.

### DESCRIPTION OF EMBODIMENTS

Wire electric discharge machines, control methods of control devices of the wire electric discharge machines, and positioning methods according to embodiments of the present invention are explained in detail below with reference to the drawings. Note that the present invention is not limited by the embodiments.

### First Embodiment

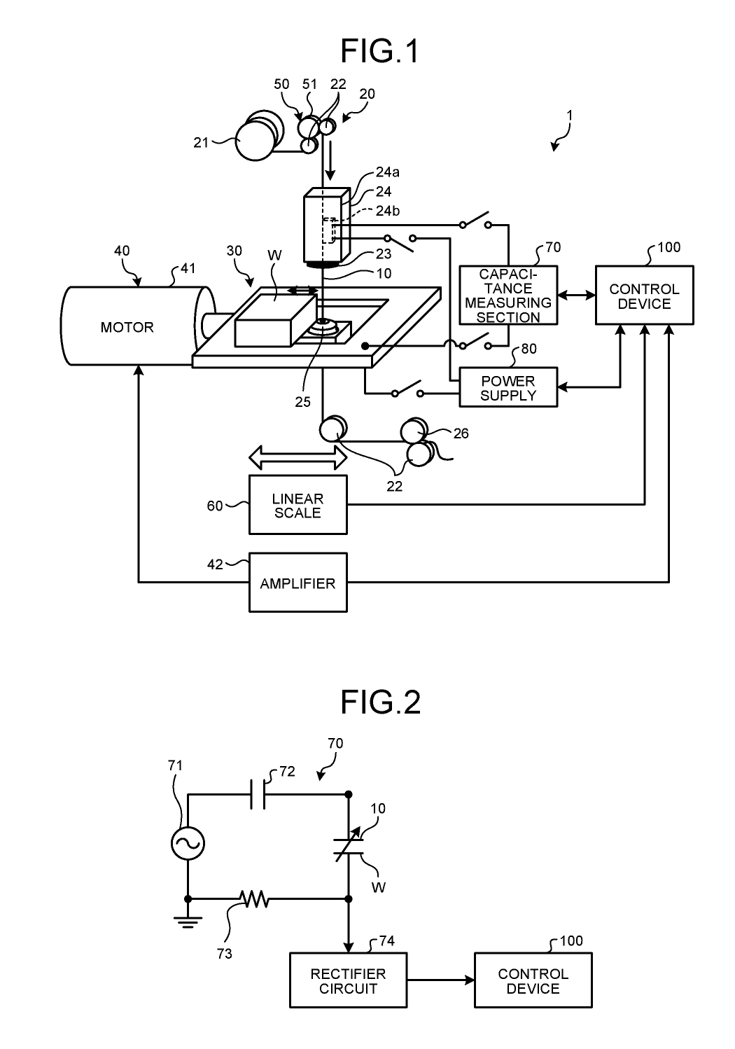

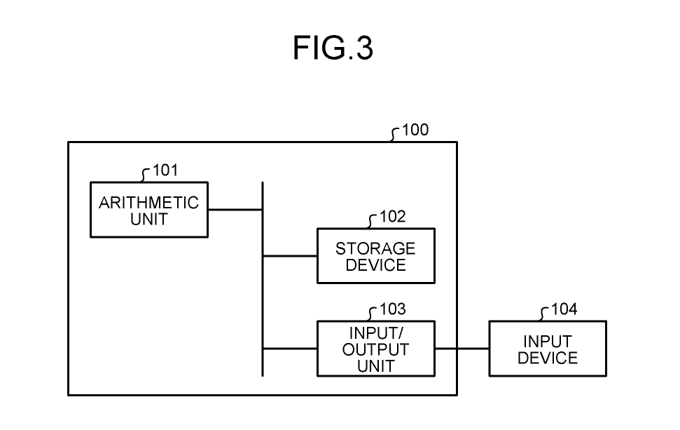

FIG. 1 is a diagram showing the configuration of a wire electric discharge machine according to a first embodiment of the present invention. FIG. 2 is a diagram showing an example of the configuration of a capacitance measuring section of the wire electric discharge machine according to the first embodiment of the present invention. FIG. 3 is a diagram showing an example of the configuration of a control device of the wire electric discharge machine according to the first embodiment of the present invention.

A wire electric discharge machine 1 is an apparatus that applies wire electric discharge machining to a work W. The wire electric discharge machine 1 includes, as shown in FIG. 1, a wire electrode 10 functioning as a discharge electrode, a wire moving section 20 that moves the wire electrode 10 along the longitudinal direction of the wire electrode 10, a work holding section 30 that holds the work W, and a driving section 40 that relatively moves the wire electrode 10 and the work W. The wire electric discharge machine 1 includes a tension applying section 50 that applies tension to the wire electrode 10, a linear scale 60, which is measuring means for measuring an amount of movement of the work W by the driving section 40, a capacitance measuring section 70 that measures capacitance between the wire electrode 10 and the work W, and a control device 100 that causes the driving section 40 to adjust relative positions of the wire electrode 10 and the work W.

The wire electrode 10 is applied with a machining voltage and causes electric discharge between the wire electrode 10 and the work W. The wire electrode 10 is configured by metal having electric conductivity and is formed in a long shape. The sectional shape of the wire electrode 10 is formed in a circular shape. In the first embodiment, the outer diameter of the wire electrode 10 is 20 micrometers or more and 300 micrometers or less.

The wire moving section 20 includes a wire bobbin 21 on which the wire electrode 10 is wound to supply the wire electrode 10, a plurality of wire feeding rollers 22, a machining head 24 including an upper nozzle 23 that delivers the wire electrode 10 toward the work W, a lower nozzle 25 through which the wire electrode 10 is inserted, and a collection roller 26 that collects the wire electrode 10. The wire feeding rollers 22 are supported rotatably around axes. At least one wire feeding roller 22 is provided between the wire bobbin 21 and the machining head 24. The wire electrode 10 is wound on the wire feeding roller 22. The wire feeding roller 22 guides the wire electrode 10 from the wire bobbin 21 to the machining head 24. At least one wire feeding roller 22 is provided between the lower nozzle 25 and the collection roller 26. The wire electrode 10 is wound on the wire feeding roller 22. The wire feeding roller 22 guides the wire electrode 10 from the lower nozzle 25 to the collection roller 26. The wire feeding roller 22 rotates according to the movement of the wire electrode 10.

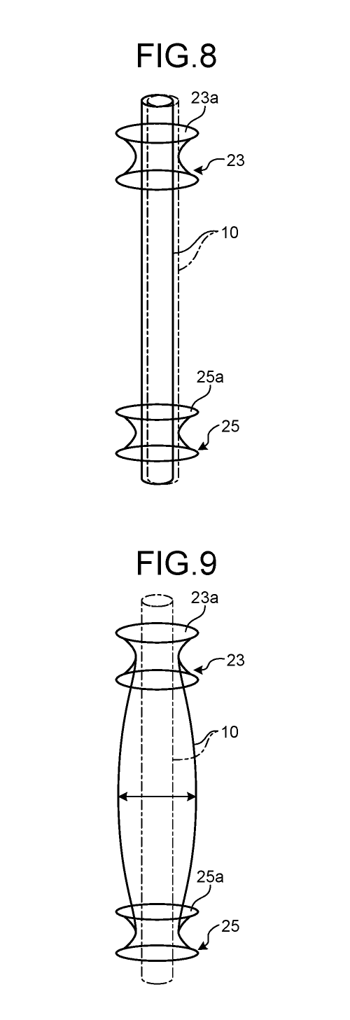

The machining head 24 includes a head main body 24a, through the inner side of which the wire electrode 10 is inserted, a contactor 24b provided in the head main body 24a and in contact with the wire electrode 10, and the upper nozzle 23 attached to the lower surface of the head main body 24a opposed to the work W. The upper nozzle 23 includes, as shown in FIG. 8, a guide hole 23a, through the inner side of which the wire electrode 10 is inserted. A difference between the inner diameter of the guide hole 23a and the outer diameter of the wire electrode 10 is several micrometers.

The lower nozzle 25 is disposed below the upper nozzle 23 of the machining head 24. The lower nozzle 25 includes, as shown in FIG. 8, a guide hole 25a, through the inner side of which the wire electrode 10 is inserted. A difference between the inner diameter of the guide hole 25a and the outer diameter of the wire electrode 10 is several micrometers. Because the wire electrode 10 is inserted through the guide holes 23a and 25a, the upper nozzle 23 and the lower nozzle 25 linearly support the wire electrode 10 between the upper nozzle 23 and the lower nozzle 25. In the first embodiment, the upper nozzle 23 and the lower nozzle 25 are opposed to each other at an interval in the vertical direction and support the wire electrode 10 present between the upper nozzle 23 and the lower nozzle 25 in parallel to the vertical direction. However, the direction in which the upper nozzle 23 and the lower nozzle 25 are opposed to each other and the longitudinal direction of the wire electrode 10 present between the upper nozzle 23 and the lower nozzle 25 can cross the vertical direction.

The collection roller 26 holds the wire electrode 10 between the collection roller 26 and the wire feeding roller 22 and is rotated by a not-shown motor. When electric discharge machining is applied to the work W, the collection roller 26 is rotated by the motor to collect the wire electrode 10 inserted through the guide hole 23a of the upper nozzle 23 and the guide hole 25a of the lower nozzle 25. When rotating speed by the motor is changed, the collection roller 26 can change the moving speed of the wire electrode 10.

The work holding section 30 is configured by metal having electric conductivity. The plane shape of the outer edge of the work holding section 30 is formed in a square frame shape. The surface of the work holding section 30 is formed flat. The work holding section 30 is disposed in parallel to the horizontal direction. The wire electrode 10 present between the upper nozzle 23 and the lower nozzle 25 is inserted through the inner side of the work holding section 30.

The driving section 40 relatively moves the wire electrode 10 and the work W in a direction crossing the longitudinal direction of the wire electrode 10 present between the nozzles 23 and 25. The driving section 40 includes a motor 41 incorporating an encoder, a not-shown ball screw rotated around an axis by the motor 41, and a not-shown nut into which the ball screw is screwed, the nut being attached to the work holding section 30. The motor 41 is connected to the control device 100 via an amplifier 42. The motor 41 rotates the ball screw around the axis. The encoder incorporated in the motor 41 measures a rotation angle of the ball screw and outputs a measurement result to the control device 100. When the motor 41 rotates the ball screw around the axis, the driving section 40 moves, with respect to the wire electrode 10, the work W held by the work holding section 30. The driving section 40 moves the work W to move the work W in directions in which the work W approaches the wire electrode 10 present between the nozzles 23 and 25 and moves away from the wire electrode 10 present between the nozzles 23 and 25.

In the first embodiment, the driving section 40 moves the work W in the direction orthogonal to the longitudinal direction of the wire electrode 10 present between the nozzles 23 and 25. However, the driving section 40 can move the work W in a direction not orthogonal to the longitudinal direction of the wire electrode 10 present between the nozzles 23 and 25. The driving section 40 can move both of the wire electrode 10 present between the nozzles 23 and 25 and the work W or can move, with respect to the work W, the wire electrode 10 present between the nozzles 23 and 25 without moving the work W.

A machining voltage is applied between the wire electrode 10 and the work W from a power supply 80. The power supply 80 is electrically connected to the wire electrode 10 via the contactor 24b and connected to the work W via the work holding section 30. The power supply 80 applies the machining voltage between the contactor 24b and the work holding section 30 to apply the machining voltage between the wire electrode 10 and the work W. The machining voltage applied by the power supply 80 is a voltage for breaking insulation between the wire electrode 10 present between the nozzles 23 and 25 and the work W, causing electric discharge, and removing a part of the work W with the electric discharge. In the first embodiment, when an inter-electrode distance, which is the distance between the wire electrode 10 present between the nozzles 23 and 25 and the work W, is 10 micrometers or more and 20 micrometers or less, the machining voltage is a voltage for causing electric discharge between the wire electrode 10 and the work W. However, the inter-electrode distance between the wire electrode 10 and the work W is not limited to be 10 micrometers or more and 20 micrometers or less.

The tension applying section 50 applies tension to the wire electrode 10 when the machining voltage is applied to the wire electrode 10 and electric discharge machining of the work W is performed. The tension applying section 50 includes a tension applying roller 51 and a not-shown motor capable of rotating the tension applying roller 51. The tension applying roller 51 is provided between the wire bobbin 21 and the machining head 24 and holds the wire electrode 10 between the tension applying roller 51 and the wire feeding roller 22. The motor of the tension applying section 50 rotates the tension applying roller 51 in a direction in which the wire electrode 10 is wound by the wire bobbin 21. The driving torque of the motor of the tension applying section 50 is weaker than the driving torque of the motor that rotates the collection roller 26. When the electric discharge machining is applied to the work W, because the motor is about to rotate the tension applying roller 51 with the driving torque weaker than the driving torque of the motor that rotates the collection roller 26, the tension applying section 50 applies tension to the wire electrode 10 along the longitudinal direction of the wire electrode 10 present between the nozzles 23 and 25.

The linear scale 60 includes a scale and a detector movably provided in the scale and fixed to the work holding section 30. The linear scale 60 measures a movement amount of the detector with respect to the scale to measure a movement amount of the work and outputs a measurement result to the control device 100. The measuring means can be, instead of the linear scale 60, means for measuring a movement amount of the work W on the basis of a driving signal of the motor 41 or a measurement result of the encoder of the motor 41.

One end of the capacitance measuring section 70 is electrically connected to the wire electrode 10 via the contactor 24b. The other end is connected to the work W via the work holding section 30. The capacitance measuring section 70 includes, as shown in FIG. 2, an AC power supply 71 for measurement that supplies a sine-wave AC voltage, a DC-component blocking capacitor 72 connected to one end of the AC power supply 71, a current detection resistor 73 connected to the grounded other end of the AC power supply 71, a rectifier circuit 74 that converts an AC voltage at a not-grounded terminal of the current detection resistor 73 into an amplitude value of the voltage and outputs the amplitude value to the control device 100. The DC-component blocking capacitor 72 is connected to the wire electrode 10 via a contactor 24b. The current detection resistor 73 is connected to the work W via the work holding section 30. The capacitance measuring section 70 measures a voltage value corresponding to the capacitance between the wire electrode 10 and the work W. The capacitance measuring section 70 outputs a measurement result to the control device 100.

The control device 100 is a numerical control device and configured by, as shown in FIG. 3, an arithmetic unit 101 such as a CPU (Central Processing Section), a RAM (Random Access Memory), a ROM (Read Only Memory), a hard disk drive, a storage device, or a nonvolatile storage device obtained by combining these devices and is configured by a computer including a storage device 102 that stores a numerical control program. The arithmetic unit 101 executes the numerical control program stored in the storage device 102, generates machining conditions, and outputs the machining conditions to the sections of the wire electric discharge machine 1, whereby the control device 100 controls the operations of the sections of the wire electric discharge machine 1. The arithmetic unit 101 executes the numerical control program stored in the storage device 102, whereby the control device 100 positions the work W with respect to the wire electrode 10. Thereafter, the control device 100 causes electric discharge between the wire electrode 10 and the work W and applies the electric discharge machining to the work W.

In the first embodiment, information necessary for generating machining conditions is input to the control device 100 from an input device 104 connected to an input/output unit 103. The input device 104 is configured by a touch panel, a keyboard, a mouse, a track ball, or a combination of these devices.

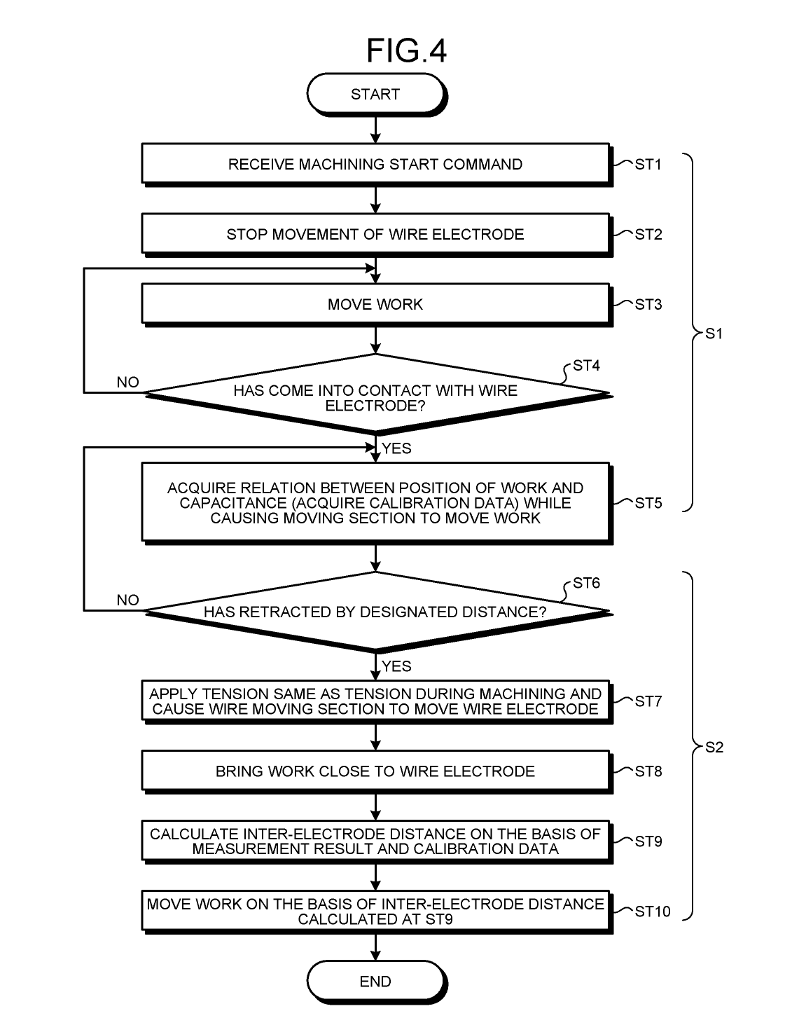

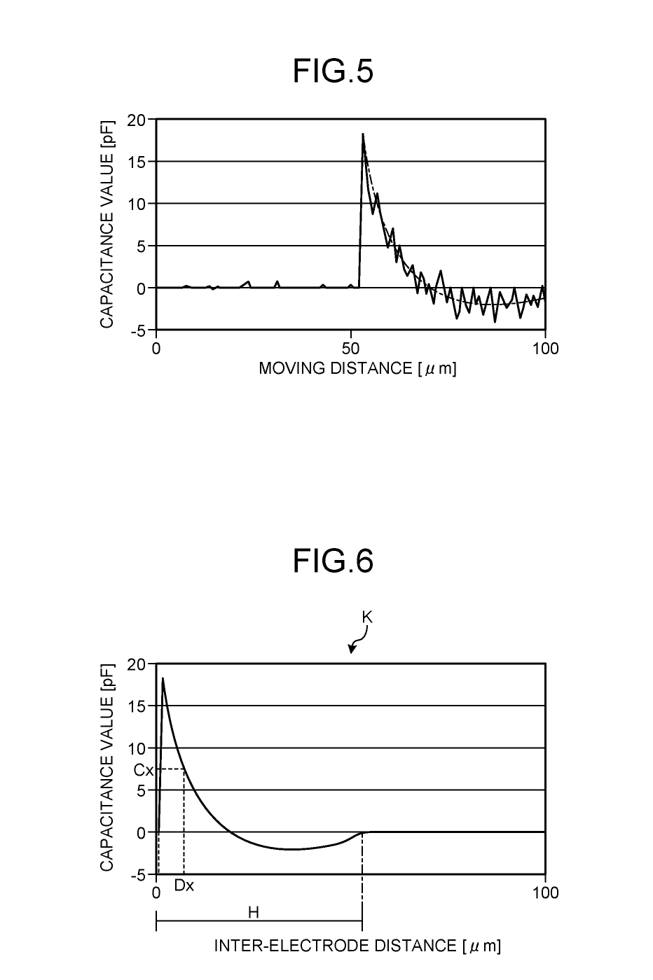

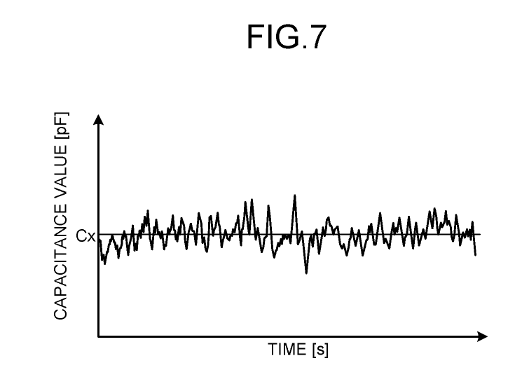

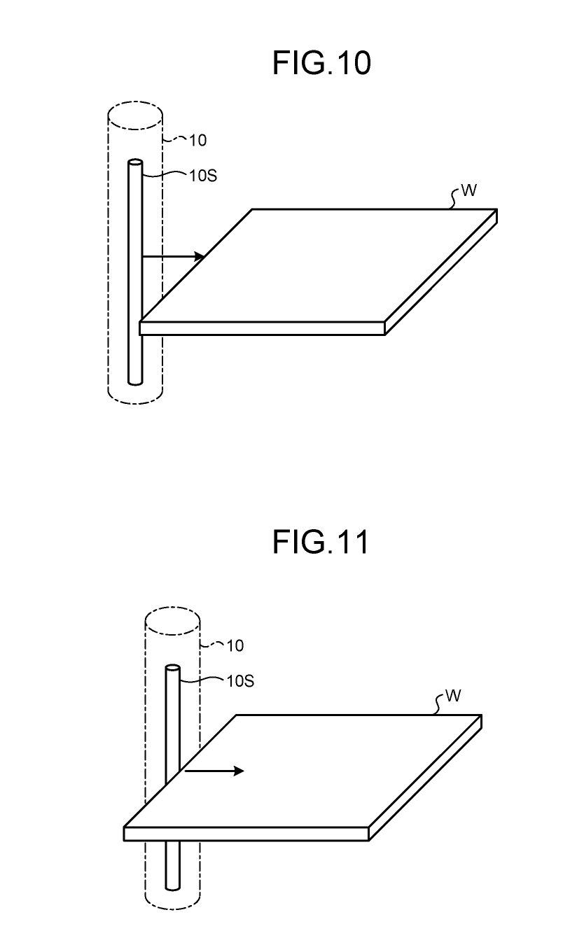

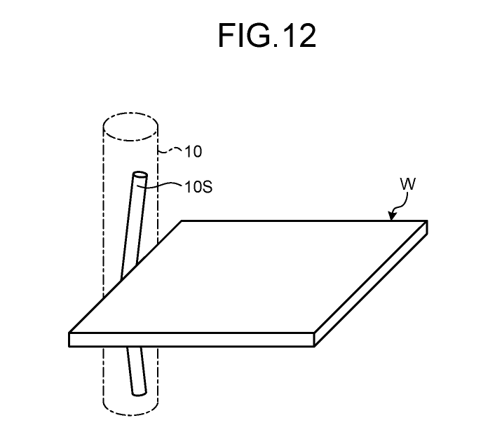

A machining operation of the wire electric discharge machine 1, a control method of the control device 100, and a positioning method according to the first embodiment are explained with reference to the drawings. FIG. 4 is a flowchart showing an example of the machining operation of the wire electric discharge machine according to the first embodiment of the present invention. FIG. 5 is a diagram showing an example of a measurement result acquired at step ST5 in FIG. 4. FIG. 6 is a diagram showing an example of calibration data acquired from a measurement result shown in FIG. 5. FIG. 7 is a diagram showing an example of capacitance corresponding to an inter-electrode distance between the wire electrode and the work calculated at step ST9 in FIG. 4. FIG. 8 is a diagram showing a state in which the wire electrode of the wire electric discharge machine according to the first embodiment of the present invention is stopped. FIG. 9 is a diagram showing a state in which the wire electrode shown in FIG. 8 is moved. FIG. 10 is a diagram showing a state in which a wire electrode is brought close to a work in a comparative example of the wire electric discharge machine according to the first embodiment. FIG. 11 is a diagram showing a state in which the wire electrode is set in contact with the work in the comparative example shown in FIG. 10. FIG. 12 is a diagram showing a state in which it is possible to detect that the work is in contact with the wire electrode of an extra fine wire in the comparative example shown in FIG. 10.

The wire electric discharge machine 1 starts a machining operation when information necessary for generating machining conditions is input and a machining start command is input to the control device 100 from the input device 104. In the machining operation, the control device 100 of the wire electric discharge machine 1 positions the wire electrode 10 and the work W on the basis of the input information. After positioning the wire electrode 10 and the work W, the control device 100 generates machining conditions on the basis of the input information and outputs the generated machining conditions to the driving section 40, the wire moving section 20, the driving section 40, and the power supply 80. Then, the power supply 80 applies a machining voltage between the wire electrode 10 and the work W. The wire electric discharge machine 1 causes electric discharge between the wire electrode 10 and the work W and applies the electric discharge machining to the work W.

In the wire electric discharge machine 1, after the work W is held by the work holding section 30, when receiving the machining start command input from the input device 104, the control device 100 executes positioning of the wire electrode 10 and the work W (step ST1). When positioning the wire electrode 10 and the work W, first, the control device 100 causes the wire moving section 20 to stop the movement of the wire electrode 10 (step ST2). The control device 100 causes the driving section 40 to move the work W in a direction approaching the wire electrode 10 (step ST3). The control device 100 determines on the basis of a measurement result of the capacitance measuring section 70 whether the work W has come into contact with the wire electrode 10 (step ST4). When the capacitance between the wire electrode 10 and the work W detected by the capacitance measuring section 70 decreases to zero, the control device 100 determines that the work W has come into contact with the wire electrode 10. When the capacitance between the wire electrode 10 and the work W detected by the capacitance measuring section 70 is not zero, the control device 100 determines that the work W has not come into contact with the wire electrode 10.

When determining that the work W has not come into contact with the wire electrode 10 (No at step ST4), the control device 100 returns to step ST3. When determining that the work W has come into contact with the wire electrode 10 (Yes at step ST4), after causing the driving section 40 to stop the movement of the work W, the control device 100 acquires a relation between the position of the work W and the capacitance between the wire electrode 10 and the work W while causing the driving section 40 to move the work W in a direction away from the wire electrode 10 (step ST5). The control device 100 associates a detection result of the linear scale 60 and the capacitance between the wire electrode 10 and the work W, which is a measurement result of the capacitance measuring section 70, in a one-to-one relation and acquires a relation between the capacitance between the wire electrode 10 and the work W and a moving distance of the work W as shown in FIG. 5. The control device 100 acquires, on the basis of the relation shown in FIG. 5, using the method of least squares, calibration data K defining a relation between the inter-electrode distance between the wire electrode 10 and the work W and the capacitance between the wire electrode 10 and the work W and stores the calibration data K, as shown in FIG. 6.

In the wire electric discharge machine 1, the control device 100 executes processing at step ST1 to step ST5 to cause, in a state in which the movement of the wire electrode 10 in the longitudinal direction is stopped, the capacitance measuring section 70 to measure capacitance while causing the driving section 40 to relatively move the wire electrode 10 and the work W. When executing the processing at step ST5 to cause the capacitance measuring section 70 to measure capacitance, the control device 100 acquires the calibration data K from the measurement result of the measurement by the capacitance measuring section 70. When executing the processing at step ST4 to cause the capacitance measuring section 70 to measure capacitance, the control device 100 brings the work W into contact with the wire electrode 10. The processing at step ST1 to step ST5 configures a calibration-data acquiring step S1 for causing, in the state in which the movement of the wire electrode 10 in the longitudinal direction is stopped, the capacitance measuring section 70 to measure capacitance while causing the driving section 40 to relatively move the wire electrode 10 and the work W.

The control device 100 determines whether the work W has retracted from the wire electrode 10 by a designated distance (step ST6). Note that, when the wire electrode 10 is moved by the wire moving section 20, the wire electrode 10 comes into contact with the inner surfaces of the guide holes 23a and 25a of the nozzles 23 and 25 and, as indicated by a solid line in FIG. 9, the wire electrode 10 vibrates in a range of maximum 10 micrometers in a direction orthogonal to the moving direction of the wire electrode 10 in the center between the nozzles 23 and 25. The designated distance is set on the basis of a range of vibration of the wire electrode 10 moved by the wire moving section 20. In the first embodiment, the designated distance is 10 micrometers, which is a maximum range in which the wire electrode 10 vibrates. However, the designated distance is not limited to 10 micrometers. When determining that the work W has not retracted from the wire electrode 10 by the designated distance (No at step ST6), the control device 100 returns to step ST5.

When determining that the work W has retracted from the wire electrode 10 by the designated distance (Yes at step ST6), the control device 100 causes the driving section 40 to stop the movement of the work W, causes the tension applying section 50 to apply tension having intensity same as the intensity during the discharge machining to the wire electrode 10, and causes the wire moving section 20 to move the wire electrode 10 at speed same as the speed during the discharge machining (step ST7). In the first embodiment, when tension same as the tension during the electric discharge machining is applied to the wire electrode 10 by the tension applying section 50 from a position indicated by a solid line in FIG. 8, the wire electrode 10, the movement of which by the wire moving section 20 is stopped, moves several micrometers in a direction orthogonal to the moving direction of the wire electrode 10 to a position indicated by an alternate long and short dash line in FIG. 8. Further, when being moved at speed same as the speed during the discharge machining by the wire moving section 20, the wire electrode 10 vibrates maximum 10 micrometers in the direction orthogonal to the moving direction of the wire electrode 10 between the nozzles 23 and 25.

The control device 100 brings the work W close to the wire electrode 10 on the basis of the measurement result of the capacitance measuring section 70 such that the work W does not come into contact with the wire electrode 10 and the work W is located within a range H shown in FIG. 6 in which the capacitance changes according to a change in the inter-electrode distance. When the work W is located within the range H shown in FIG. 6, the control device 100 stops the movement of the work W (step ST8).

The control device 100 causes the capacitance measuring section 70 to measure the capacitance between the wire electrode 10 and the work W. At this point, as indicated by a solid line in FIG. 9, the wire electrode 10 vibrates in the center of the guide holes 23a and 25a of the nozzles 23 and 25 in a direction orthogonal to the longitudinal direction of the wire electrode 10. Therefore, the capacitance between the wire electrode 10 and the work W increases and decreases according to the elapse of time as shown in FIG. 7. The control device 100 calculates an average of the measured capacitance and sets the average as a value Cx shown in FIG. 7 of the capacitance between the wire electrode 10 and the work W. In the first embodiment, the average of the capacitance is an arithmetic mean.

The control device 100 calculates an inter-electrode distance between the wire electrode 10 moving in the longitudinal direction and the work W on the basis of the value Cx of the capacitance, which is the measurement result of the capacitance measuring section 70, and the calibration data K shown in FIG. 6 acquired at step ST5 (step ST9). In the first embodiment, the control device 100 calculates an inter-electrode distance Dx between the wire electrode 10 and the work W corresponding to the value Cx of the capacitance in the calibration data K shown in FIG. 6 and sets the inter-electrode distance Dx as the inter-electrode distance between the wire electrode 10 and the work W. The control device 100 causes the driving section 40 to move the work W to a position at the inter-electrode distance from the wire electrode 10 corresponding to the machining conditions, which are set during the electric discharge machining, on the basis of the inter-electrode distance between the wire electrode 10 and the work W calculated at step ST9 and the detection result of the linear scale 60 (step ST10). As an example, the control device 100 calculates a difference between the inter-electrode distance between the wire electrode 10 and the work W calculated at step ST9 and the inter-electrode distance between the wire electrode 10 and the work W corresponding to the machining conditions, causes the driving section 40 to move the work W in a direction in which the difference is zero, and sets, from the detection result of the linear scale 60, a movement amount of the work W to a value corresponding to the difference. The control device 100 completes the positioning of the wire electrode 10 and the work W. Thereafter, the control device 100 causes the capacitance measuring section 70 to stop the measurement of the capacitance, causes the power supply 80 to apply the machining voltage between the wire electrode 10 and the work W according to the machining conditions, and applies the electric discharge machining to the work W. When the wire electric discharge machine 1 applies the electric discharge machining to the work W, machining fluid configured by pure ware or machining oil is supplied to between the wire electrode 10 and the work W.

In the wire electric discharge machine 1, the control device 100 executes the processing at step ST6 to step ST10 to cause the capacitance measuring section 70 to measure capacitance while causing the wire moving section 20 to move the wire electrode 10 in the longitudinal direction and cause the driving section 40 to adjust the relative positions of the wire electrode 10 and the work W on the basis of the measurement result of the capacitance measuring section 70. The control device 100 executes the processing at step ST7 to, when causing the driving section 40 to adjust the relative positions of the wire electrode 10 and the work W, cause the tension applying section 50 to apply tension having intensity same as the intensity in applying the electric discharge machining to the wire electrode 10. The control device 100 executes the processing ate step ST9 to, when causing the driving section 40 to adjust the relative positions of the wire electrode 10 and the work W, calculate the inter-electrode distance between the wire electrode 10 moving in the longitudinal direction and the work W on the basis of the value Cx of the capacitance, which is the measurement result of the capacitance measuring section 70, and the calibration data K. The processing at step ST6 to step ST10 configures an adjusting step S2 for causing, in a state in which the control device 100 causes the wire moving section 20 to move the wire electrode 10 in the longitudinal direction, the capacitance measuring section 70 to measure capacitance and causing the driving section 40 to adjust the relative positions of the wire electrode 10 and the work W.

As explained above, in the wire electric discharge machine 1, the control method of the control device 100, and the positioning method according to the first embodiment, the control device 100 calculates the inter-electrode distance between the wire electrode 10 and the work W on the basis of the capacitance between the wire electrode 10 and the work W. Therefore, in the wire electric discharge machine 1, the control method of the control device 100, and the positioning method according to the first embodiment, the capacitance changes according to a change in the inter-electrode distance between the wire electrode 10 and the work W. The capacitance decreases to zero when the wire electrode 10 and the work W come into contact. Therefore, it is possible to more accurately measure the inter-electrode distance between the wire electrode 10 and the work W than the comparative example shown in FIG. 10, FIG. 11, and FIG. 12 in which a position where by wire electrode 10 and the work W are in contact is detected according to electric conduction between the wire electrode 10 and the work W. As a result, in the wire electric discharge machine 1, the control method of the control device 100, and the positioning method according to the first embodiment, it is possible to accurately position the wire electrode 10 and the work W.

In the comparative example shown in FIG. 10, FIG. 11, and FIG. 12, the wire electrode 10 is an extra fine wire 10S having an outer diameter of 70 micrometers or less.

When the work W is brought close to the extra fine wire 10S as shown in FIG. 10, even if the extra fine wire 10S and the work W come into contact as shown in FIG. 11, the contact sometimes cannot be detected because a contact area is small. In this case, in the comparative example, the work W is brought closer to the extra fine wire 10S. It is detected that, as shown in FIG. 12, the extra fine wire 10S and the work W are in contact in a position where the work W is moved closer to the extra fine wire 10S than a position where the extra fine wire 10S and the work W are in contact shown in FIG. 11. As opposed to such a comparative example, in the wire electric discharge machine 1, in the control method of the control device 100, and the positioning method according to the first embodiment, even if the wire electrode 10 is the extra fine wire 10S, when the extra fine wire 10S and the work W come into contact, the capacitance between the extra fine wire 10S and the work W immediately decreases to zero. Therefore, it is possible to accurately detect a position where the extra fine wire 10S and the work W are in contact. It is possible to accurately measure the inter-electrode distance between the extra fine wire 10S and the work W.

In the wire electric discharge machine 1, the control method of the control device 100, and the positioning method according to the first embodiment, the control device 100 calculates the inter-electrode distance between the wire electrode 10 and the work W on the basis of the capacitance between the wire electrode 10 and the work W. As a result, in the wire electric discharge machine 1, the control method of the control device 100, and the positioning method according to the first embodiment, even when the machining oil is used as the machining fluid, it is possible to accurately grasp the inter-electrode distance between the wire electrode 10 and the work W and accurately position the wire electrode 10 and the work W.

In the wire electric discharge machine 1, the control method of the control device 100, and the positioning method according to the first embodiment, in the state in which the movement of the wire electrode 10 in the longitudinal direction is stopped, the control device 100 causes the capacitance measuring section 70 to measure the capacitance between the wire electrode 10 and the work W while relatively moving the wire electrode 10 and the work W in the direction crossing the longitudinal direction of the wire electrode 10. Therefore, in the wire electric discharge machine 1, the control method of the control device 100, and the positioning method according to the first embodiment, even if the wire electrode 10 vibrates when the wire electrode 10 is moved in the longitudinal direction, the capacitance is measured in the state in which the wire electrode 10 is stopped. Therefore, it is possible to acquire an accurate relation between the inter-electrode distance between the wire electrode 10 and the work W and the capacitance between the wire electrode 10 and the work W.

In the wire electric discharge machine 1, the control method of the control device 100, and the positioning method according to the first embodiment, in the state in which the movement of the wire electrode 10 in the longitudinal direction is stopped, after causing the capacitance measuring section 70 to measure the capacitance between the wire electrode 10 and the work W, the control device 100 causes the capacitance measuring section 70 to measure capacitance while causing the wire moving section 20 to move the wire electrode 10 in the longitudinal direction and causes the driving section 40 to adjust the relative positions of the wire electrode 10 and the Work W. Therefore, even if the relative positions of the wire electrode 10 and the work W deviate between the state in which the wire electrode 10 is stopped and the state in which the wire electrode 10 is moved, before positioning the wire electrode 10, it is possible to accurately calculate the inter-electrode distance between the wire electrode 10 moving in the longitudinal direction and the work W on the basis of the capacitance acquired in the state in which the wire electrode 10 is stopped. As a result, in the wire electric discharge machine 1, the control method of the control device 100, and the positioning method according to the first embodiment, it is possible to accurately position the wire electrode 10 and the work W.

In the wire electric discharge machine 1, the control method of the control device 100, and the positioning method according to the first embodiment, in the state in which the movement of the wire electrode 10 in the longitudinal direction is stopped, the control device 100 causes the capacitance measuring section 70 to measures the capacitance between the wire electrode 10 and the work W and acquires the calibration data K defining the relation between the inter-electrode distance between the wire electrode 10 and the work W and the capacitance between the wire electrode 10 and the work W. As a result, in the wire electric discharge machine 1, the control method of the control device 100, and the positioning method according to the first embodiment, even if the wire electrode 10 vibrates when the wire electrode 10 is moved in the longitudinal direction, the relative positions of the wire electrode 10 and the work W are adjusted on the basis of the calibration data K acquired in the state in which the wire electrode 10 is stopped. Therefore, it is possible to accurately position the wire electrode 10 and the work W.

In the wire electric discharge machine 1, the control method of the control device 100, and the positioning method according to the first embodiment, the control device 100 positions the wire electrode 10 and the work W on the basis of the calibration data K acquired in the state in which the movement of the wire electrode 10 in the longitudinal direction is stopped. Therefore, in the wire electric discharge machine 1, the control method of the control device 100, and the positioning method according to the first embodiment, the calibration data K acquired using the wire electrode 10 and the work W used in actual machining is used. Therefore, even if the shape of at least one of the wire electrode 10 and the work W variously changes, it is possible to accurately position the wire electrode 10 and the work W.

In the wire electric discharge machine 1, the control method of the control device 100, and the positioning method according to the first embodiment, after acquiring the relation between the inter-electrode distance between the wire electrode 10 and the work W and the capacitance between the wire electrode 10 and the work W, the control device 100 moves the wire electrode 10 in the longitudinal direction and calculates the inter-electrode distance between the wire electrode 10 and the work W. Therefore, even if the relative positions of the wire electrode 10 and the work W deviate between the state in which the wire electrode 10 is stopped and the state in which the wire electrode 10 is moved, before positioning the wire electrode 10, it is possible to calculate the inter-electrode distance between the wire electrode 10 moving in the longitudinal direction and the work W. As a result, in the wire electric discharge machine 1, the control method of the control device 100, and the positioning method according to the first embodiment, before positioning the wire electrode 10 and the work W, the control device 100 moves the wire electrode 10 in the same manner as during the electric discharge machining. Therefore, it is possible to measure the inter-electrode distance between the wire electrode 10 and the work W during the electric discharge machining. It is possible to accurately position the wire electrode 10 and the work W.

In the wire electric discharge machine 1, the control method of the control device 100, and the positioning method according to the first embodiment, the control device 100 calculates the inter-electrode distance between the moving wire electrode 10 and the work W using the value Cx, which is the average of the capacitance that is the measurement result of the capacitance measuring section 70. Therefore, in the wire electric discharge machine 1, the control method of the control device 100, and the positioning method according to the first embodiment, even if the moving wire electrode 10 vibrates, it is possible to accurately measure the inter-electrode distance between the wire electrode 10 and the work W. It is possible to accurately position the wire electrode 10 and the work W.

In the wire electric discharge machine 1, the control method of the control device 100, and the positioning method according to the first embodiment, the control device 100 measures the inter-electrode distance between the moving wire electrode 10 and the work W in a state in which tension same as the tension during the electric discharge machining is applied to the wire electrode 10 by the tension applying section 50. Therefore, even if the relative positions of the wire electrode 10 and the work W deviate between the state in which the tension is applied to the wire electrode 10 and the state in which tension is not applied to the wire electrode 10, before positioning the wire electrode 10, it is possible to accurately calculate the inter-electrode distance between the wire electrode 10 moving in the longitudinal direction and the work W. As a result, in the wire electric discharge machine 1, the control method of the control device 100, and the positioning method according to the first embodiment, before positioning the wire electrode 10 and the work W, because the tension same as the tension during the electric discharge machining is applied to the wire electrode 10, it is possible to measure the inter-electrode distance between the wire electrode 10 and the work W during the electric discharge machining. It is possible to accurately position the wire electrode 10 and the work W.

In the wire electric discharge machine 1, the control method of the control device 100, and the positioning method according to the first embodiment, when acquiring the calibration data K defining a relation between the inter-electrode distance between the wire electrode 10 and the work W and the capacitance between the wire electrode 10 and the work W, the control device 100 once brings the wire electrode 10 and the work W into contact. Therefore, in the wire electric discharge machine 1, the control method of the control device 100, and the positioning method according to the first embodiment, it is possible to measure the inter-electrode distance between the wire electrode 10 and the work W on the basis of the position where the wire electrode 10 and the work W are in contact. As a result, in the wire electric discharge machine 1, the control method of the control device 100, and the positioning method according to the first embodiment, it is possible to accurately position the wire electrode 10 and the work W.

### Second Embodiment

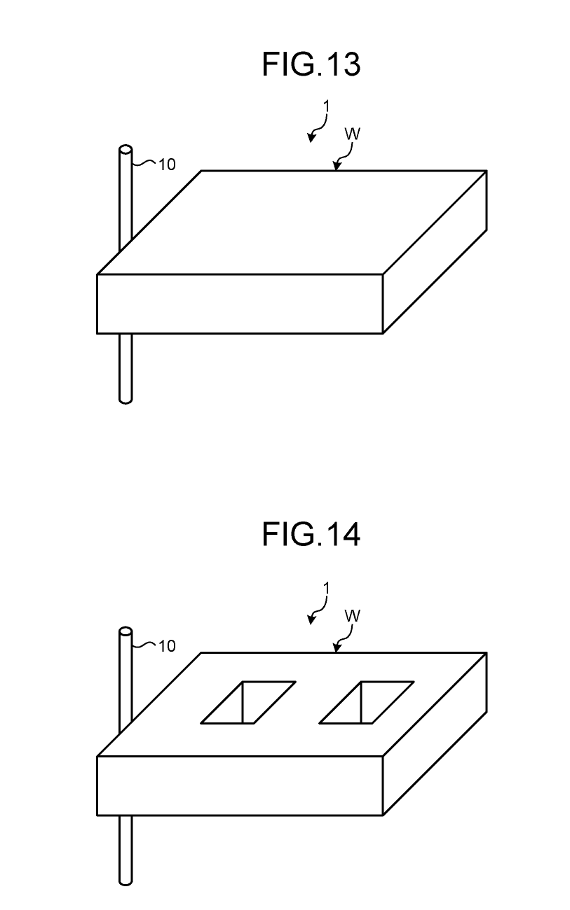

The wire electric discharge machine 1 according to a second embodiment of the present invention is explained with reference to the drawings. FIG. 13 is a perspective view showing a wire electrode and a work before first cut of the wire electric discharge machine according to the second embodiment of the present invention. FIG. 14 is a perspective view showing the wire electrode and the work before second cut of the wire electric discharge machine according to the second embodiment of the present invention. In FIG. 13 and FIG. 14, sections same as the sections in the first embodiment are denoted by the same reference numerals and signs and explanation of the sections is omitted.

The wire electric discharge machine 1 according to the second embodiment has a configuration same as the configuration in the first embodiment. The wire electric discharge machine 1 shown in FIG. 13 and FIG. 14 according to the second embodiment performs first cut for applying gouging to the work W through electric discharge machining and thereafter performs second cut for applying a machining voltage lower than the machining voltage in the first cut between the wire electrode 10 and the work W and relatively moving the wire electrode 10 and the work W in a route same as the route in the first cut. In the second cut, the wire electric discharge machine 1 finishes a surface machined by the first cut. In the wire electric discharge machine 1, in the first cut, machining accuracy is sometimes deteriorated because of at least one of a temperature rise of machining fluid supplied to between the wire electrode 10 and the work W and internal distortion that occurs in the work W.

The control device 100 of the wire electric discharge machine 1 according to the second embodiment measures a relative position of the wire electrode 10 relative to any position of the work W according to a measurement result of the capacitance measuring section 70 before the first cut and before the second cut. The control device 100 of the wire electric discharge machine 1 according to the second embodiment compares a measurement result before the first cut and a measurement result before the second cut and measures positional deviation between the wire electrode 10 and the work W during the first cut. During the second cut, the control device 100 of the wire electric discharge machine 1 according to the second embodiment corrects, taking into account the positional deviation, a route for relatively moving the wire electrode 10 and the work W. During the second cut, the wire electric discharge machine 1 according to the second embodiment performs an operation same as the operation in the first embodiment except that the wire electric discharge machine 1 corrects the route for relatively moving the wire electrode 10 and the work W.

As in the first embodiment, when positioning the wire electrode 10 and the work W, the wire electric discharge machine 1 according to the second embodiment acquires the calibration data K in the state in which the movement of the wire electrode 10 in the longitudinal direction is stopped. Thereafter, the wire electric discharge machine 1 moves the wire electrode 10 in the longitudinal direction and calculates an inter-electrode distance between the wire electrode 10 and the work W on the basis of the calibration data K. As a result, as in the first embodiment, the wire electric discharge machine 1 according to the second embodiment can accurately position the wire electrode 10 and the work W.

During the second cut, the wire electric discharge machine 1 according to the second embodiment corrects the route for relatively moving the wire electrode 10 and the work W. Therefore, it is possible to suppress the deterioration in the machining accuracy.

### Third Embodiment

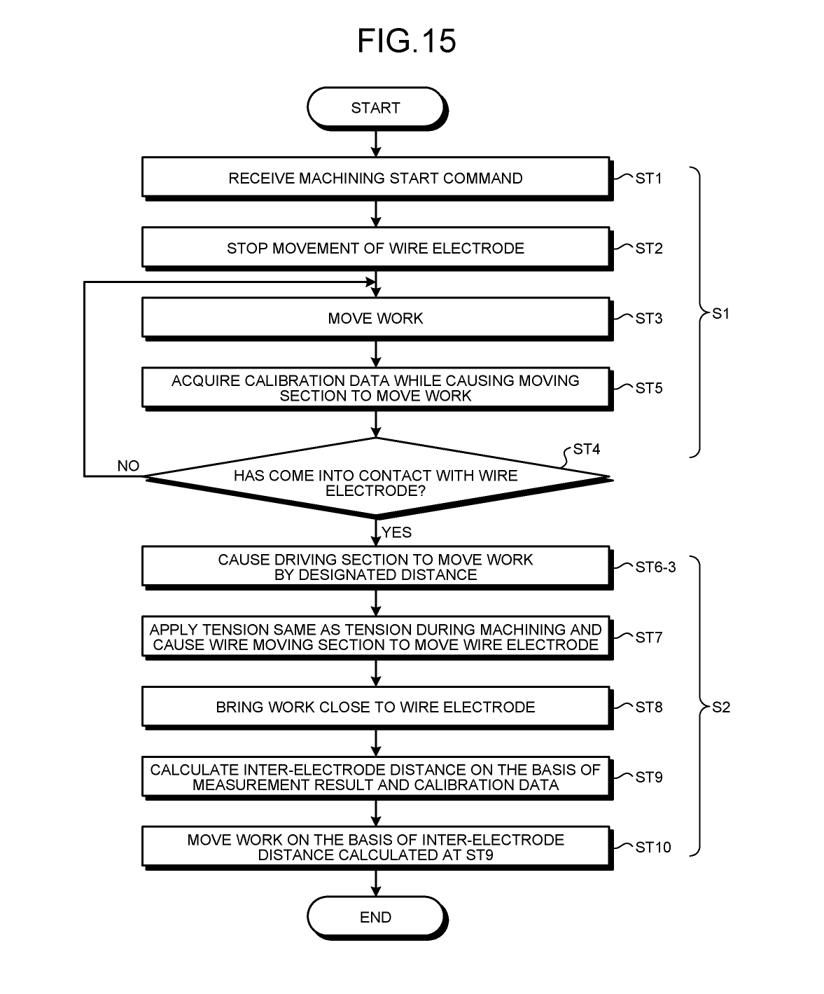

The wire electric discharge machine 1 according to a third embodiment is explained with reference to the drawings. FIG. 15 is a flowchart showing an example of a machining operation of the wire electric discharge machine according to the third embodiment of the present invention. In FIG. 15, steps same as the steps in the first embodiment are denoted by the same reference signs and explanation of the steps is omitted.

The wire electric discharge machine 1 according to the third embodiment has a configuration same as the configuration in the first embodiment. The control device 100 of the wire electric discharge machine 1 according to the third embodiment moves the work W in a direction approaching the wire electrode 10 (step ST3) and thereafter acquires and stores the calibration data K while moving the work W in the direction approaching the wire electrode 10 (step ST5).

While acquiring the calibration data K, the control device 100 determines on the basis of a measurement result of the capacitance measuring section 70 whether the work W has come into contact with the wire electrode 10 (step ST4). When determining that the work W has not come into contact with the wire electrode 10 (No at step ST4), the control device 100 returns to step ST3. When determining that the work W has come into contact with the wire electrode 10 (Yes at step ST4), the control device 100 causes the driving section 40 to move the work W in a direction away from the wire electrode 10 and moves the work W until the work W retracts from the wire electrode 10 by a designated distance (step ST6-3). When the work W retracts from the wire electrode 10 by the designated distance, as in the first embodiment, the control device 100 executes the processing at step ST7, step ST8, step ST9, and step ST10.

When positioning the wire electrode 10 and the work W, as in the first embodiment, the wire electric discharge machine 1 according to the third embodiment acquires the calibration data K in the state in which the movement of the wire electrode 10 in the longitudinal direction is stopped. Thereafter, the wire electric discharge machine 1 moves the wire electrode 10 in the longitudinal direction and calculates an inter-electrode distance between the wire electrode 10 and the work W on the basis of the calibration data K. As a result, as in the first embodiment, the wire electric discharge machine 1 according to the third embodiment can accurately position the wire electrode 10 and the work W.

The wire electric discharge machine 1 according to the third embodiment acquires, while bringing the work W close to the wire electrode 10, the calibration data K until the work W comes into contact with the wire electrode 10. As a result, the wire electric discharge machine 1 according to the third embodiment can suppress time required for positioning the wire electrode 10 and the work W.

### Fourth Embodiment

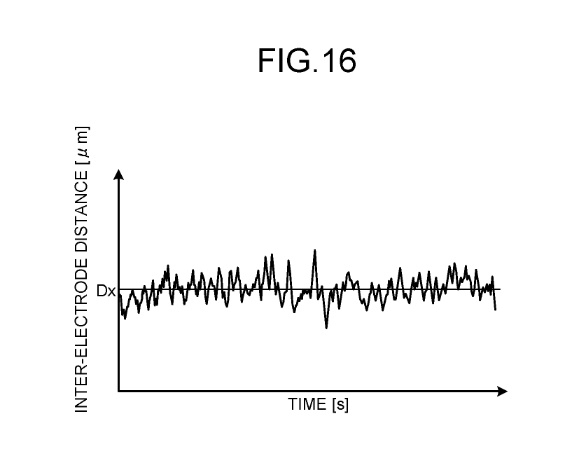

The wire electric discharge machine 1 according to a fourth embodiment is explained with reference to the drawings. FIG. 16 is a diagram showing an example of an inter-electrode distance between a wire electrode and a work calculated by a control device of the wire electric discharge machine according to the fourth embodiment of the present invention.

The wire electric discharge machine 1 according to the fourth embodiment has a configuration same as the configuration in the first embodiment. When calculating the inter-electrode distance between the wire electrode 10 and the work W at step ST9, the control device 100 of the wire electric discharge machine 1 according to the fourth embodiment converts the capacitance between the wire electrode 10 and the work W measured by the capacitance measuring section 70 into the inter-electrode distance between the wire electrode 10 and the work W on the basis of the calibration data K. The control device 100 acquires the inter-electrode distance between the wire electrode 10 and the work W that changes according to the elapse of time as shown in FIG. 16. The control device 100 calculates an average of the acquired inter-electrode distance and sets the average as the inter-electrode distance Dx between the wire electrode 10 and the work W. In the fourth embodiment, the average of the acquired inter-electrode distance is an arithmetic mean. The control device 100 controls the sections of the wire electric discharge machine 1 as in the first embodiment except step ST9.

When positioning the wire electrode 10 and the work W, as in the first embodiment, the wire electric discharge machine 1 according to the fourth embodiment acquires the calibration data K in the state in which the movement of the wire electrode 10 in the longitudinal direction is stopped. Thereafter, the wire electric discharge machine 1 moves the wire electrode 10 in the longitudinal direction and calculates the inter-electrode distance between the wire electrode 10 and the work W on the basis of the calibration data K. As a result, the wire electric discharge machine 1 according to the fourth embodiment can accurately position the wire electrode 10 and the work W as in the first embodiment.

When calculating the inter-electrode distance between the wire electrode 10 and the work W at step ST9, the wire electric discharge machine 1 according to the fourth embodiment converts the capacitance measured by the capacitance measuring section 70 into the inter-electrode distance between the wire electrode 10 and the work W and sets an average of the inter-electrode distance as the inter-electrode distance Dx between the wire electrode 10 and the work W. As a result, the wire electric discharge machine 1 according to the fourth embodiment can accurately calculate the inter-electrode distance between the wire electrode 10 and the work W and can accurately position the wire electrode 10 and the work W.

The configurations explained in the embodiments indicate examples of the contents of the present invention. The configurations can be combined with other publicly-known technologies. A part of the configurations can be omitted and changed in a range not departing from the spirit of the present invention.

### REFERENCE SIGNS LIST

1 wire electric discharge machine
10 wire electrode
20 wire moving section
40 driving section
50 tension applying section
70 capacitance measuring section
100 control device
W work

1. A wire electric discharge machine comprising:
a wire electrode that is applied with a machining voltage and causes electric discharge between the wire electrode and a work;
a driving section that relatively moves the wire electrode and the work in a direction crossing a longitudinal direction of the wire electrode;
a wire moving section that moves the wire electrode in the longitudinal direction;
a capacitance measuring section that measures capacitance between the wire electrode and the work; and
a control device that causes, in a state in which the movement of the wire electrode in the longitudinal direction is stopped, the capacitance measuring section to measure the capacitance while causing the driving section to relatively move the wire electrode and the work, thereafter, causes, in a state in which the control device causes the wire moving section to move the wire electrode in the longitudinal direction, the capacitance measuring section to measure the capacitance, and causes the driving section to adjust relative positions of the wire electrode and the work on the basis of a measurement result of the capacitance measuring section.

2. The wire electric discharge machine according to claim 1, further comprising a tension applying section that applies tension to the wire electrode along the longitudinal direction, wherein
the control device causes, in a state in which the control device causes the wire moving section to move the wire electrode in the longitudinal direction, the capacitance measuring section to measure the capacitance and, when causing the driving section to adjust the relative positions of the wire electrode and the work, causes the tension applying section to apply tension same as the tension in applying electric discharge machining to the wire electrode.

3. The wire electric discharge machine according to claim 2, wherein, in a state in which the movement of the wire electrode in the longitudinal direction is stopped, when causing the capacitance measuring section to measure the capacitance while causing the driving section to relatively move the wire electrode and the work, the control device acquires calibration data defining a relation between a distance between the wire electrode and the work and the capacitance from the measurement result of the measurement by the capacitance measuring section.

4. The wire electric discharge machine according to claim 3, wherein, in the state in which the movement of the wire electrode in the longitudinal direction is stopped, when causing the capacitance measuring section to measure the capacitance while causing the driving section to relatively move the wire electrode and the work, the control device causes the wire electrode to come into contact with the work.

5. The wire electric discharge machine according to claim 4, wherein, in a state in which the control device causes the wire moving section to move the wire electrode in the longitudinal direction, when causing the capacitance measuring section to measure the capacitance and causing the driving section to adjust the relative positions of the wire electrode and the work, the control device calculates the distance between the wire electrode moving in the longitudinal direction and the work on the basis of the measurement result of the capacitance measuring section and the calibration data.

6. A control method of a control device of a wire electric discharge machine including: a wire electrode that is applied with a machining voltage and causes electric discharge between the wire electrode and a work; a driving section that relatively moves the wire electrode and the work in a direction crossing a longitudinal direction of the wire electrode; a wire moving section that moves the wire electrode in the longitudinal direction; and a capacitance measuring section that measures capacitance between the wire electrode and the work,
a control method comprising:
a calibration-data acquiring step for causing, in a state in which the movement of the wire electrode in the longitudinal direction is stopped, the capacitance measuring section to measure the capacitance while causing the driving section to relatively move the wire electrode and the work; and
an adjusting step for causing, in a state in which the wire moving section is caused to move the wire electrode in the longitudinal direction, the capacitance measuring section to measure the capacitance and causing the driving section to adjust relative positions of the wire electrode and the work.

7. A positioning method comprising:
a calibration-data acquiring step for, in a state in which movement of a wire electrode, which is applied with a machining voltage and causes electric discharge between the wire electrode and a work, in a longitudinal direction is stopped, measuring capacitance between the wire electrode and the work while relatively moving the wire electrode and the work in a direction crossing the longitudinal direction; and
an adjusting step for measuring the capacitance between the wire electrode and the work in a state in which the wire electrode is moved along the longitudinal direction and adjusting relative positions of the wire electrode and the work in a direction crossing the longitudinal direction.
